(19) United States
(12) Patent Application Publication
(10) Pub. No.: US 2013/0006810 A1
(43) Pub. Date: Jan. 3, 2013

(54) Method and system for the execution of non-bank Third Party Services Transactions over Financial Networks through Electronic Terminals utilizing a Non-Depository Virtual Account Management System

(76) Inventor: Aurelio Elias, Hurst, TX (US)

(21) Appl. No.: 13/539,386

(22) Filed: Jun. 30, 2012

Related U.S. Application Data
(60) Provisional application No. 61/503,316, filed on Jun. 30, 2011.

(51) Int. Cl. G06Q 40/00; G06Q 30/06; G06Q 20/10

(52) U.S. Cl. 705/26.41; 705/44; 705/39

(57) ABSTRACT

The present embodiment of the system is a new and useful method and system for automating Third Party Financial Transactions via an Electronic Transaction Apparatus, by enabling a Transaction Acquirer Processor and a Third Party Service Provider to provide a Financial Instrument Holder, access to a non-bank third party service and complete a transaction utilizing a Non-depository Virtual Account Management System, when the individual's requests a third party transaction on an Electronic Terminal device.

This application claims the benefit of Provisional Patent Application Ser. No. 61,503,316, filed by present inventor, which is incorporated by reference.

### BACKGROUND

### Prior Art

The following is a tabulation of some prior art that presently appears relevant:

United States Patents

| Pat. No. | Issue Date | Patentee |
|---|---|---|
| 5,650,604 | July 1997 | Marcous, et al. |
| 6,000,608 | December 1999 | Dorf |
| 6,796,492 | September 2004 | Gatto |
| 7,182,252 | February 2007 | Cooper, et al. |
| 7,195,151 | March 2007 | Licciardello, et al. |
| 7,363,265 | April 2008 | Horgan |
| 7,415,442 | August 2008 | Battaglini, et al. |
| 7,416,115 | August 2008 | Licciadello, et al. |
| 7,580,898 | August 2009 | Brown, et al. |
| 7,627,524 | December 2009 | Bennett, et al. |
| 7,644,037 | January 2010 | Battaglini, et al. |
| 7,664,703 | February 2010 | Hansen, et al. |
| 7,665,657 | February 2010 | Huh |
| 7,693,790 | April 2010 | Lawlor, et al. |
| 7,708,199 | May 2010 | Gatto |
| 7,720,754 | May 2010 | Gutierrez-Sheris |
| 7,780,075 | August 2010 | Cooper, et al. |
| 7,792,748 | September 2010 | Ebersole, et al. |
| 7,801,799 | September 2010 | Brake, Jr., et al. |
| 7,802,718 | September 2010 | Barcelou |
| 8,032,457 | October 2011 | Ostrovsky |
| 8,038,058 | October 2011 | Licciardello, et al. |
| 8,131,643 | March 2012 | Battaglini, et al. |

Although numerous patents exist, including those listed above that presently appear relevant, the present embodiment of the system is novel and substantially different in a plurality of elements, thus rendering the embodiment unobvious to a person skilled in the art. However, it is recognized that there is a significant body of prior art in the fields of electronic money transfers, electronic payments and financial accounts, including but not limited to cards, virtual accounts, computer systems, automated teller machines and other computing devices that utilize or access financial networks. The present embodiment of the system describes a method and system that is superior to the prior art, that includes but is not limited to a new and novel way for financial instrument holders to access third party financial services on electronic terminals that is more universally useable and more versatile in operation. The present embodiment of the system also provides for a new and useful way to access third party financial services through electronic terminal devices by utilizing a non-depository virtual account management system.

In view of the limitations now present in the prior art, the present embodiment of the system provides a new and useful method and system for offering an individual the ability to access a third party service over existing financial networks using the terminal's processor as the qualifier and executor of the transaction.

In today's economic environment, it often occurs that an individual will go to an automated teller machine (ATM) or a point of sale (POS) terminal and only have access to a limited set of services currently provided (e.g. cash withdrawal, balance inquiry, purchase, etc.) but in fact may have the need to carry out other types of transactions (e.g. money transfer, pay a bill, get a loan, etc.) Currently there is no method or system to enable an individual access to additional third party services on electronic terminals unless the electronic terminals are controlled by the financial instrument issuer (e.g. bank) or the third party services provider. This holds true for the Merchant Vendor based transaction on a POS System; where the transaction is a direct purchase of goods or services but where the inclusion of the Third Party Services Provider is rendered inaccessible. An example of such a transaction is a non sufficient funds (NSF) overage event on the individual's financial instrument during the payment process on an electronic terminal device resulting in a denial of the transaction during the time of purchase due to a willing lender being inaccessible to extend credit an effect an authorization.

The purpose of the present embodiment of the system is to provide a new method of authorizing access to a third party financial service transaction utilizing the existing financial network systems (e.g. acquiring processor, electronic terminal interface, settlement management system and financial network protocols). The current state of the art does not offer this option to individuals at the electronic terminal level. Currently, the individual's financial instrument issuer (e.g. credit/debit card issuer) is the only source of transaction authorization available unless the electronic terminal is programmed to directly access a third party service. This embodiment of the system has many novel features not offered by the prior art apparatus that result in a new and much needed method for an alternative for accessing third party services by using a Non-Depository Virtual Account Management System, a Third Party Services Provider and an Acquiring Processor which is simpler in construction, and which is not apparent, obvious, or suggested, either directly or indirectly by any of the prior art apparatus and more universally usable (utilizing existing financial network systems) and more versatile in operation (combining third party processors and third party services) than known apparatus of this kind

### ADVANTAGES

The present embodiment of the system demonstrates a new and improved method and system for the issuance of a third party service over a financial network system by utilizing a non-depository virtual account management system, comprising:
Providing a financial transaction system enabling the execution of a third party service over a financial network by acquiring processors and non-bank third party services providers.
Utilizing electronic transaction terminals, acquirer processing systems and third party services processing systems in a novel way to enable a holder of a financial instrument to access a third party services at the time of a transaction request.
Utilizing a combination of personal service information, non-depository virtual accounts for transaction auditing and depository settlement accounts for transaction settlement enabling third party services providers to offer Pay-In and Pay-Out transactions on the existing financial network systems.

### SUMMARY

The present embodiment of the system that is a new and useful method and system for the execution of Third Party Services Transactions over Financial Networks through Electronic Terminals utilizing a Non-Depository Virtual Account Management System and a unique combination of data sets and financial network messaging management system processes.

In view of the limitations now present in the prior art, the present embodiment of the system provides a new and useful method for offering an individual the ability to access aggregated personal services information during a single financial transaction acquiring session on an Electronic Terminal, when the individual has selected a particular financial transaction, the Acquiring Processor has identified the user and the Non-Depository Virtual Account Management System has associated the Financial Instrument Holder with a Third Party Services Provider, communicates the transaction details to the Financial Instrument Holder thus providing an optional (Opt-In or Opt-Out) event on the Electronic Terminal for authorizing the payment by using the Acquiring Processor as the qualifier and executor of the transaction.

The present embodiment of the system relates generally to the field of apparatus and methods for automated financial transactions that occur via the use of a individual's financial instrument (e.g. credit/debit card, check, token or cash), an electronic terminal (e.g. computer, telephone, automated teller machine or point-of-sale terminal), an electronic funds transfer transaction acquiring processor and a provider of third party financial services. Moreover it pertains specifically to such apparatus for the management and execution of the automated financial transactions over existing financial networks utilizing among other elements, an aggregate of personal and third party services information, and a non-depository virtual account to facilitate the transaction over existing systems resulting in authorization and settlement of the transaction utilizing a non-depository virtual account management system, an acquiring processor and a third party services provider.

The foregoing has outlined, in general, the physical aspects of the present embodiment of the system and is to serve as an aid for better understanding the more complete detailed description which is to follow. In reference to such, there is to be a clear understanding that the present embodiment of the system is not limited to the method or detail of construction, fabrication, material, or application of use described and illustrated herein. Any other variation of fabrication, use, or application should be considered apparent as an alternative embodiment of the present system.

This embodiment of the system relates generally to the field of apparatus and processes for automated financial transactions that occur via the use of an individual's aggregated personal services information (e.g. Name, Account Number, Account Balance, Biller Information, Credit Limit, etc.), an Electronic Terminal (e.g. Automated Teller Machine, Point of Sale Terminal, Personal Computer, Telecommunications Device), an electronic funds transfer (EFT) Acquiring Processor of financial transactions (e.g. ACH, Debit, Credit), a Non-Depository Virtual Account Management System, Third Party Services Management System and a Third Party Services Provider (e.g. Lender, Bill Payment Aggregator, Money Transfer Service, Prepaid Load Network, etc.)

When the Financial Instrument Holder initiates the transaction on the Electronic Terminal device and the Acquiring Processor validates and authenticates the Financial Instrument Holder, the Non-Depository Virtual Account Management System indentifies the Third Party Services Provider, and sends a request to access the personal service information with the Third Party Financial Services Provider, either existing in the Non-Depository Virtual Account Management System or obtained from the Third Party Services Management System from which the Acquiring Processor receives an authorization from the Third Party Financial Services Provider with transaction details (including but not limited to the amount, terms and conditions, and fees associated with completing the transaction) which are communicated in whole or part to the Financial Instrument Holder through the Acquiring Processor via the Electronic Terminal interface, and thus enabling the Financial Instrument Holder to opt-in or opt-out of the transaction. The Financial Instrument Holder can be pre-qualified by the Non-Depository Virtual Account Management System with the personal service information having pre-loaded values such as, terms and conditions, fund limits and pre-authorization conditions.

Moreover it pertains specifically to such apparatus for the execution of the option for individuals to access their aggregated personal service information from the Third Party Financial Service Provider, authorizing the transaction and effect a settlement during a single transaction acquiring session with the Acquiring Processor on an Electronic Terminal.

When the Financial Instrument Holder: 1) Initiates the financial transaction on an Electronic Terminal, that communicates a series of Transaction Request and Transaction Response messages through the Processing Switch, 2) the Acquiring Processor of the EFT transaction identifies and authenticates the Financial Instrument Holder, and 3) the Non-Depository Virtual Account Management System identifies and authorize access to the Third Party Services Management System, 4) the Third Party Services Provider denies or authorizes the requested transaction and if authorized the 5) Third Party Services Management System communicates to the Financial Instrument Holder through the Acquiring Processor and the Electronic Terminal interface, the terms of the transaction and any fees associated with completing the transaction, 6) the Financial Instrument Holder is given the option to accept or refuse the transaction; 7) if the Financial Instrument Holder accepts the transaction, the Third Party Services Provider authorizes the transaction and 8) the Non-Depository Virtual Account Management System initiates the Financial Transaction Settlement process for the transaction through the Acquiring Processor via the use of the Virtual Service Accounts (Non-Depository), Operating Accounts (Depository) and Settlement Accounts which settles the amount of the authorized by the Virtual Account Holder Client and Virtual Account Holder Vendor. Depending upon the state of art and implementation of this system, this transaction can happen in seconds.

To execute the above process requires understanding of: 1) a variety of transaction terminals, their design, specifications, distribution, use, managing software and communications protocols, 2) the processes of financial transaction messaging transmissions and protocols, managing software and hardware, 3) interfaces to third party service provider systems and protocols, 4) the required elements to implement another set of financial transactional messages to enable an individual to gain access to additional services and 5) a method for settlement of the requested service transaction. The invention is described below.

### DRAWINGS—FIGURES

The following drawings further describe by illustration the advantages and objects of the present invention. Each drawing is referenced by corresponding figure reference characters within the “DETAILED DESCRIPTION OF THE INVENTION” section to follow.

FIG. 1. is a view of the Operational Domains utilized according to the present invention.

FIG. 2. Overview of the Third Party Services Network Flow

FIG. 3. Enrolling a Client for Third Party Services

FIG. 4. Transaction System—Request Authorization for Service

FIG. 5. Transaction System—Response for Service

FIG. 6. Third Party Service Transaction Types

FIG. 7. Settlement Account Types

FIG. 8. Settlement Process Overview

FIG. 9. Overview of Service Management System

FIG. 10. Service Management System Functions

FIG. 11. Transaction Message Cycle

FIG. 12. Communications Standards for Financial Network Transaction Processing

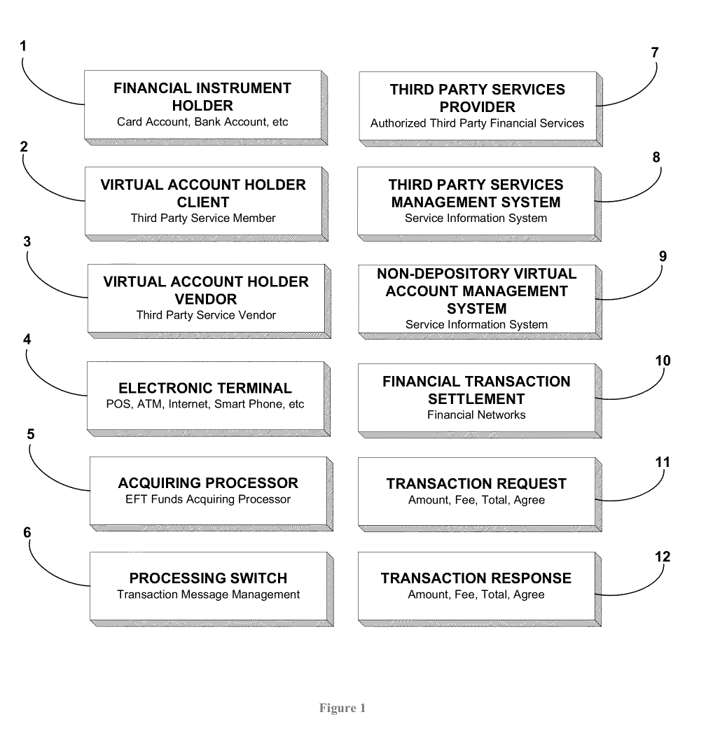

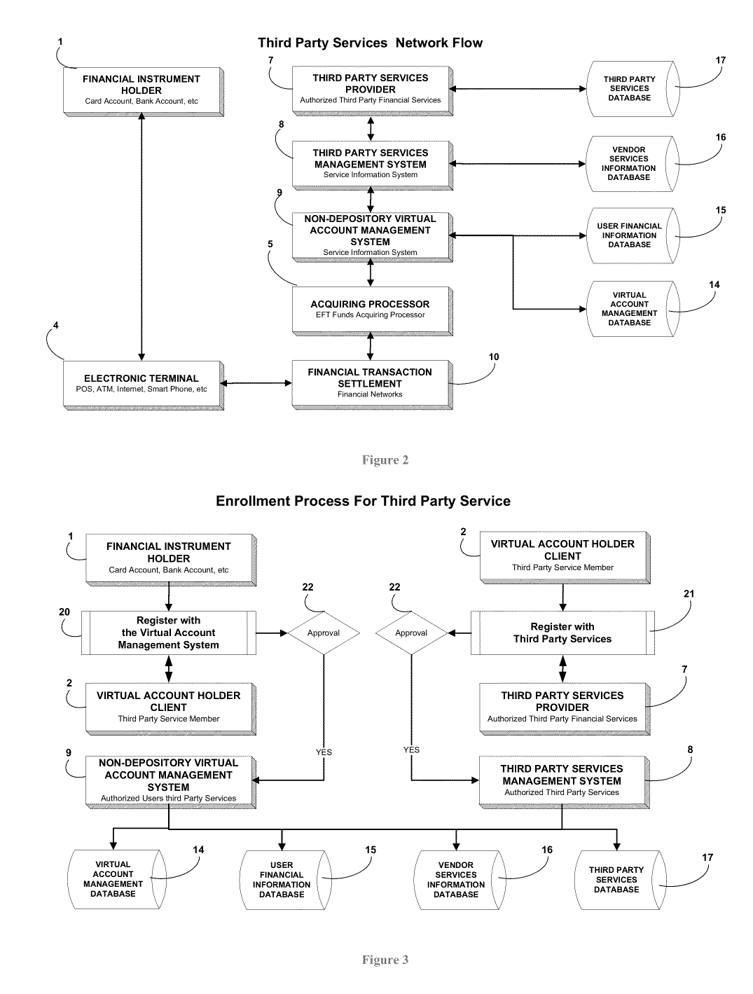

### DETAILED DESCRIPTION—FIGS. 1 AND 2—FIRST EMBODIMENT

Referring now descriptively to the drawings, the attached figures illustrate the first embodiment of the systems as a new and useful method for execution of Third Party Services Transaction over Financial Networks through Electronic Terminals utilizing a Non-Depository Virtual Account Management System.

FIG. 1 illustrates the various operational domains utilized according to the present embodiment, the domain categories are:
1. A Financial Instrument Holder: A holder of a Credit Card, Prepaid Card, Debit Card, Bank Account, Check, Token or Cash.
2. A Non-Depository Virtual Account Holder Client: An authorized User/Client who has registered to use the Third Party Services System.
3. A Non-Depository Virtual Account Holder Vendor: An authorized Third Party Services Provider who has registered to use the Third Party Services System.
4. An Electronic Terminal: A terminal interface device setup the purpose of facilitating a financial transaction used to communicate a request and complete a transaction. Such as: POS terminal, ATM, Internet Computer, Smart Phone, Kiosk, etc.
5. An Acquiring Processor: An Electronic Funds Transfer Acquiring Processor who handles the transaction requests and responses. Transaction acquiring processing includes various operational elements to complete a financial transaction request. There are three main components of the acquiring transaction: 1) Financial Networks that allow access to the participating financial institutions that issue financial instruments for transaction authorization or denial, 2) an Acquirer Processor that acquires the transactions through an Electronic Terminal, and 3) an Acquirer Bank Settlement Account for transaction settlement funds.
6. Processing Switch: Financial transaction message executor and protocol manager.
7. Third Party Services Provider: The Provider of the third party service. Such as: Money Transmitter, Lender, Bill Payment Aggregator, etc.
8. Third Party Services Management System: The part of the Service Information System that contains and handles the necessary data for the Third Party Service to issue their services within the Service Information System.
9. Non-Depository Virtual Account Services Management System: The part of the Service Information System that contains and handles the necessary data for the User to access and utilize third party services within the Service Information System.
10. Financial Transaction Settlement: The settlement process for both Pay-Out and Pay-In transactions where funds are moved between users, merchants, processors and banks
11. Transaction Request: A message protocol from the electronic terminal interface device to processor system.
12. Transaction Response: A message protocol from processor system to the electronic terminal interface device.

FIG. 2 illustrate the flow of a transaction that utilizes the Third Party Services Management System. A Financial Instrument Holder (1) utilizing a Electronic Terminal (4) sends a request for service (10) through the Electronic Terminal's Acquiring Processor (5) who manages the transaction message cycle. The identity of the Financial Instrument Holder (1) is checked by the Non-Depository Virtual Account Services Management System (9) for authorization for use of the third party service utilizing various data elements (14)(15). If further transaction authorization is required the Third Party Services Management System (8) collects necessary data from data within the Vendor Services Information Database (16) as well as data from the Third Party Services Provider (7)(17) providing the requested service. If the transaction is authorized all the above data is updated to reflect the transaction so that Financial Transaction Settlement (10) takes place and the Financial Instrument Holder (1) receives the requested service.

### Operation—FIGS. 3, 4, 5, 6, 7, 8, 9, 10, 11, 12

FIG. 3 illustrates the enrollment process for a client to obtain access to third party services. A

Financial Instrument Holder (1) registers' (20) for access to Third Party Services through the Virtual Account Services Management System (9), if approved (22), the Financial Instrument Holder (1) is issued a virtual account number and becomes a Virtual Account Holder Client (2). This process enables the Client (2) to access third party services. The Client (2) than registers with the third party financial service (21), upon approval (22), the Third Party Service Provider (7) authorizes the Virtual Account Holder Client (2) via the Third Party Services Management System (8) which updates all necessary data elements (14,15,16,17) for the Virtual Account Holder Client (2) to utilize that service over the network.

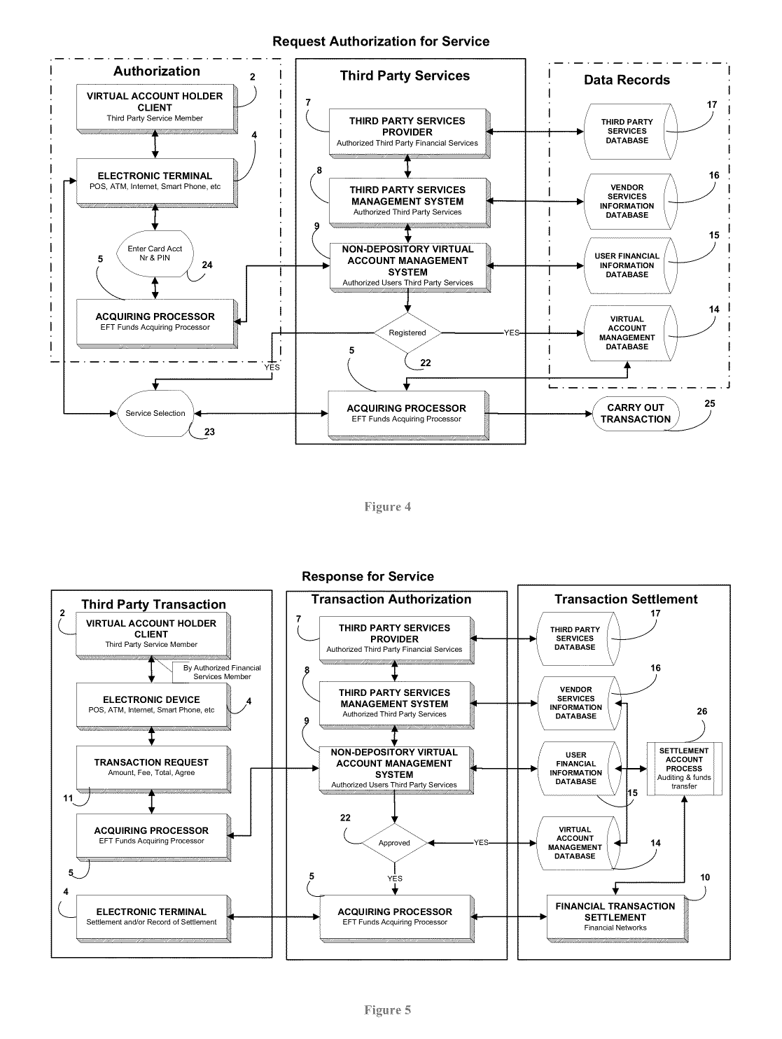

FIG. 4 illustrates the transaction process for a user to request and carryout a transaction involving a third party financial service. The Virtual Account Holder Client (2) utilizing an Electronic Terminal (4) enters (as an example) the card-account number and PIN (24) which in turn is handled by the Acquiring Processor (5). The Non-Depository Virtual Account Management System (9) qualifies the client as a registered user (22) enabling the Financial Instrument Holder (1) to select the transaction type (23) and thus carrying out the third party transaction (25).

FIG. 5 illustrates the response for the request for third party service transaction, where the Financial Instrument Holder (2) has been identified as a registered user and able to execute a third party transaction (11). The Acquiring Processor (5) transmits and receives the necessary authorization (22) and information regarding the transaction (7,8,9) to complete the transaction (10), whereby the financial settlement (26) is processed utilizing the various data elements located in various databases (14,15,16) regarding the transaction gathered by the Third Party Services Management System (8) and distributed by the Non-Depository Virtual Account Management System (9) thereby providing settlement instructions.

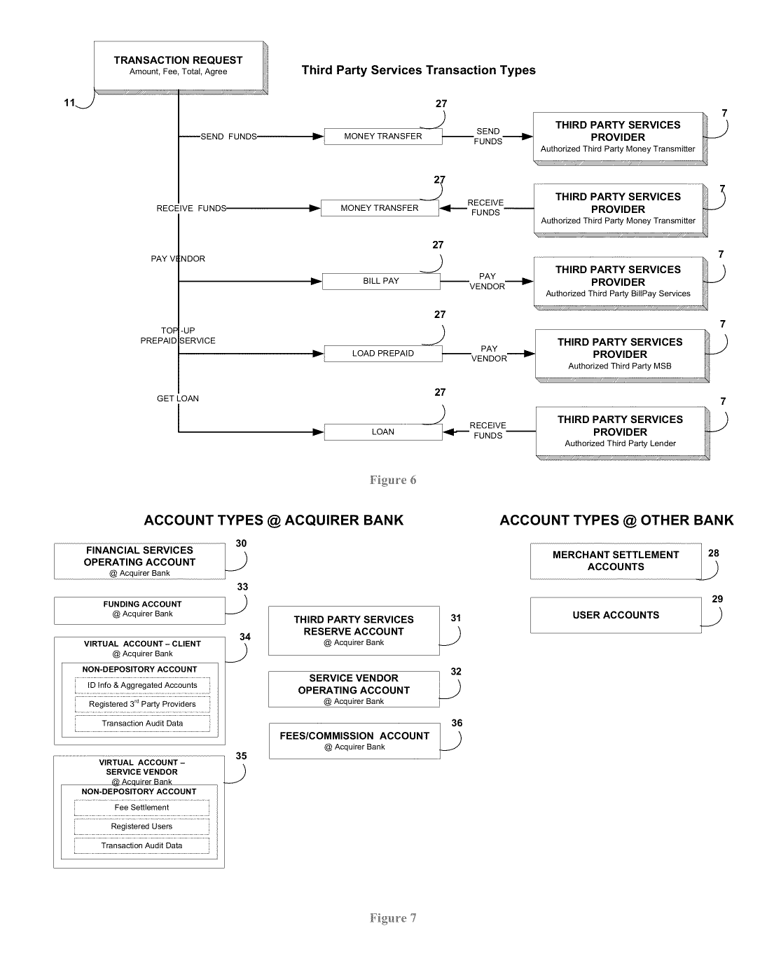

FIG. 6 illustrates an example of the various third party transaction types that may be utilized by the Third Party Services System. Each of the transaction types (27) has a specific provider of service (7). Each of the transaction types have a pay-in and pay-out (see arrows) protocol for settlement.

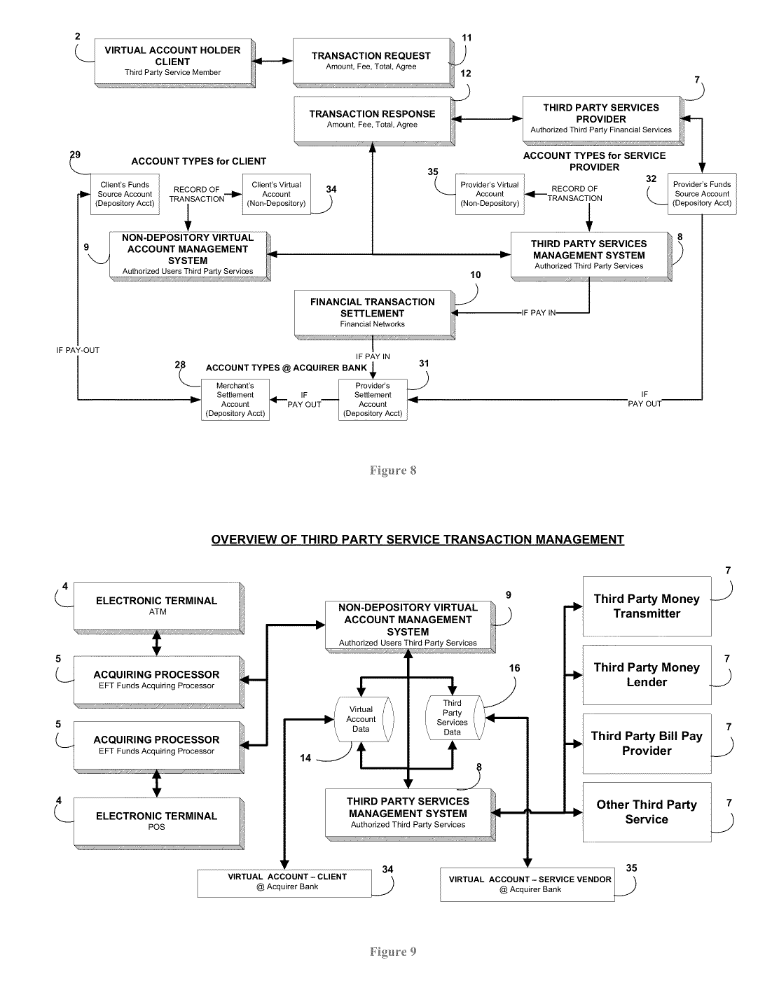

FIG. 7 illustrates the various accounts required (as an example) for third party services transaction settlement. The Financial Services Operating Account (30) is the active account where all third party transaction funds are settled to or from and is controlled by the Acquiring Processor. The Funding Account (33) funds the Operating Account (30) and is controlled by the Acquirer Processor. The Services Vendor Operating Account (32) can be referred to as a ‘Corresponding Bank Account’, is the active account where all third party transaction settlements due to the specific Third Party Service Provider (7) are settled and is controlled by Third Party Service Provider. The Third Party Services Reserve Account (31) has reserve funds available to cover any minimum balance requirements for the Financial Services Operating Account (30) and is controlled by the Non-Depository Virtual Account Services Management System (9). The Fee and Commissions Account (36) holds settlements pertaining to the transaction. The Merchant Settlement (28) and User Accounts (29) are the source accounts for transactions resulting in pay-outs as well as the recipient accounts for transactions resulting in pay-ins. Both the Virtual Account Holder Client (34) and the Virtual Account Holder Vendor (35) are non-depository accounts that are utilized by the Virtual Account Services Management System (9) to record, audit, report and enable settlement through the other accounts. One set of virtual accounts are for the Virtual Account Holder Client (2) and the other set of accounts are for the Virtual

Account Holder Vendor (3).

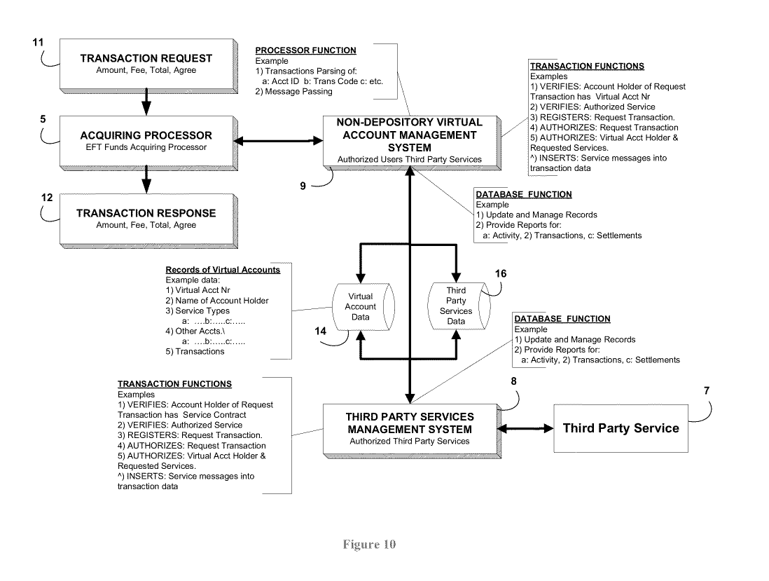

FIG. 8 illustrates the third party transaction settlement cycle, where the Virtual Account Holder Client (2) has entered a transaction (11) for a third party service. The settlement process begins when the transaction has been accepted by the third party. The Transaction Response (12) provides the audit trail data required for issuing the instructions for settlement. The combination of the Non-Depository Virtual Account Management System and Third Party Services Management System (8) gather the needed data elements in order to effect a PAY-IN or PAY-OUT transaction and settle funds through the appropriate settlement account (28,31) into the corresponding depository accounts( 29,32).

FIG. 9 illustrates the management of a third party transaction. Where the Electronic Terminal is an ATM (4) or a POS machine (4) all transactions are processed thru an Acquiring Processor (5). The selected elements of the transaction data is processed through the Non-Depository Account Management System (9). Non-Depository Virtual Account Management System (9) contains executable software code that accesses both Virtual Account Data (14) and Third Party Services Data (16) to determine whether or not the Financial Instrument Holder (1) is a Virtual Account Holder Client (2) and which third party services are available to the Client. The creation, maintenance and updating of Virtual Account Data and Third Party Services Data occurs from both the Non-Depository Virtual Account Management System (9) and the Third Party Management System (8).

When transaction is complete, sufficient data to audit the transaction is placed within the Virtual Account Holder Client (2)'s data within the Non-Depository Virtual Account Client (34) and the Virtual Account Holder Vendor (3)'s data within the Non-Depository Virtual Account Vendor (35). This data (14,16) within the Virtual Account Client and the Virtual Account Service Vendor (34,35) triggers the settlement message process, which depending upon the nature of the transaction (type and Pay-In/Pay-Out characteristics) sends the settlement message to the Merchant Settlement Account (28) (Depository) with funds from the Client's Funds Source Account (29) and to the Provider's Settlement Account (31) (Depository) for settlement to the Merchant Settlement Account (28) (Depository). Financial Transaction Settlement (10) involves a number of participants with process elements for transmitting settlements within their systems. Both the Non-Depository Virtual Account Management System (9) and the Third Party Services Management System (8) supply data necessary for the Financial Transaction Settlement (10).

The Third Party Services Management System (8) monitors the Provider's Settlement Account (31) to determine if and when the Third Party Service Provider (7) must transfer funds to the Provider's Settlement Account (31) (Depository) from the Provider's Settlement Account (31) (Depository) to sustain funds sufficient to settle transactions attributed to their services.

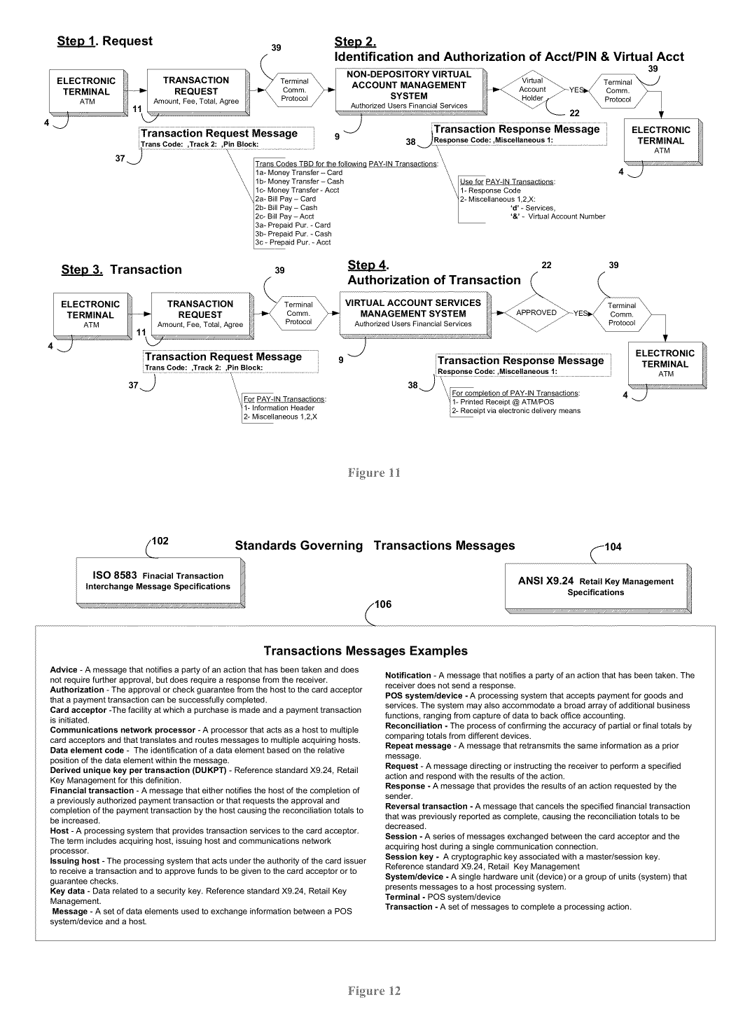

FIG. 10 illustrates an example of the data sets and functions that may be used for the execution, auditing and settlement of a third party transaction. See description texts within the figure for explanations of data field types. The Non-Depository Account Management System (9) in some cases may have to handle various message processes on top of the Acquiring Processor's (5) function;

Including but not limited to message parsing, verifying and authorizing a transaction, inserting service messages into the transaction stream and well as updating various data (14,16).

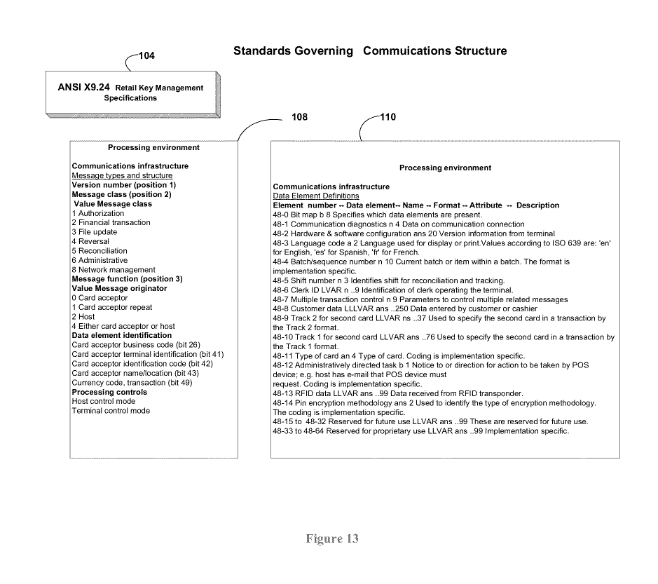

FIG. 11 illustrates an example of the data sets and functions (37, 38) that may be used to support the

Terminal Communications Protocol (39) stage of the transaction by the Transaction Request (11) step.

FIG. 12 illustrates two of the standards governing the transaction process over financial networks used by processors worldwide are: ISO 8583(102) and ANSI X9.24 (104). These standard file formats govern the following processes in the current invention: Transaction Request (11), Transaction Response (12) and Electronic Terminal (4) communications to the Acquiring Processor (5), Processing Switch (6). Illustrations of transaction message examples (106).

### CONCLUSION, RAMIFICATIONS, AND SCOPE

In conclusion the reader will see that present embodiment of the system provides a more reliable and more useful method of enabling access to third party financial services through electronic terminals via financial networks than currently exists in the prior art. While the above description contains many specificities, these should not be construed as limitations on the scope, but rather as an exemplification of one embodiment thereof Many other variations are possible.

Furthermore any ramifications that may arise from one or more elements being eliminated or duplicated, connected or associated with each other in a different manner, given a different mode or function of operation and/or made integrally or separately that may arise from future technological innovations or modifications in the financial networks' or electronic terminals' communications specification protocols does not materially invalidate the claims made herein.

Accordingly, the scope should be determined not by the embodiment illustrated, but the appended claims and their legal equivalents. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

### GLOSSARY OF TERMS

1. Acquiring Processor: The host data processing entity that acquires the transaction from the electronic terminal.
2. Electronic Terminal: Any electronic terminal that can effect a payment.
3. Financial Instrument Holder: An individual that possesses the means of effecting a payment at an electronic terminal in a Pay-In transaction or conversely receives a payment at an electronic terminal in a Pay-Out event.
4. Financial Networks: Any network that enables electronic funds transfers via electronic terminals.
5. Financial Network Settlement: The settlement of funds that are paid and received by the relevant parties to the transaction.
6. Pay-In Transaction: A payment event in which a financial instrument holder effects a payment to a third party through an electronic terminal.
7. Pay-Out Transaction: A payment event in which a financial instrument holder
8. receives a payment from a third party through an electronic terminal.
9. Processing Switch: The network access for the Electronic Terminal to the Acquiring Processor and the Virtual Account Management System.
10. Merchant Vendor: Any merchant that owns and/or operates electronic terminals such as ATM and POS systems.
11. Non-Depository Virtual Account Management System: A system of managing non depository accounts that enable financial instrument holders to access third party vendor systems during the course of a single session on an electronic terminal and to pass the data between the financial instrument holder and the third party service provider through the electronic terminal's transaction acquiring processor.
12. Operating Accounts (Depository): Accounts that can accept deposits held at depository institutions including bank accounts and stored value accounts.
13. Settlement Accounts: Temporary custodial accounts held at depository institutions for the purpose of settling funds between the relevant parties in a transaction.
14. Third Party Services Management System: A system that is managed by the Third party Service Provider that stores Virtual Account Holder Client data and authorizes or denies the Transaction Request from the Financial Instrument Holder.
15. Third Party Service Provider: Any third party providing a service that is not a depository institution.
16. Transaction Request: The transaction request through the Processing Switch for an authorization or declined transaction response.
17. Transaction Response: The transaction response through the Processing Switch to authorize or decline a transaction request.
18. Virtual Account Holder Client: The virtual account holder member that has registered with the Virtual Account Management System.
19. Virtual Account Holder Vendor: The third party services provider that has registered with the Virtual Account Management System.
20. Virtual Service Accounts (Non-Depository): Accounts that do not accept deposits and are used to provide access to third party services through financial networks.

I claim:

1. A new method and system for the issuance of a third party service's financial transaction over financial networks, comprising:
a. Providing a financial transaction system for the execution of said third party service's financial transaction through a financial network as requested by an individual financial instrument holder, and
b. Providing said financial transaction system for the settlement of said third party service's financial transaction as requested by said individual financial instrument holder over financial networks utilizing acquiring processors, merchant vendors, financial instrument issuing banks and third party service providers.
c. Providing a new use data set for the identification and authorization of said individual financial instrument holder request of said third party service's financial transaction utilized by said financial networks' transaction system.
d. Providing said new use data set for said identification and authorization of said requested third party service's financial transaction utilized by said third party service providers.
e. Providing said new use data set for said identification and authorization of said requested third party service's financial transaction utilized by an acquiring processor.
f. Providing said new use data set for said identification and authorization of said requested third party service's financial transaction utilized by a merchant vendor servicing third party service's financial transactions.
g. Providing said new use data set for said identification and authorization of said requested third party service's financial transaction utilized by said individual financial instrument holder's depository account for settlement of said third party service's financial transaction.
h. Providing said new use data set for said identification and authorization of said requested third party service's financial transaction utilized by the individual's financial instrument issuer.
i. Providing said new use data set that is compatible with the financial network's messaging protocols.
Whereby an individual requests said transaction with said third party service provider other than a direct bank or merchant vendor servicing third party service's financial transactions transaction that can than be carried out on existing financial networks.

2. A method for making the transaction of claim 1 comprising a non-depository account management system for the integration and generation of a data set message used for said identification and authorization process of said requested third party service's financial transaction.

3. A method and system for the settlement of said third party service's financial transaction over financial networks; by providing for the management of the execution and settlement of said third party service's financial transaction over financial networks utilizing existing financial networks, merchants vendors, acquiring processors, financial instrument (card) management systems, financial instrument issuers and financial network protocols:

4. A method for settling the transaction of claim 3 comprising:
a. Providing a non-depository account management system for transaction identification, authorization and settlement of said third party service's financial transaction.
b. Providing a new method for said third party service's financial transaction to be authorized and settled through the financial network utilizing said non-depository account management system.
c. Providing a new method for said third party service's financial transaction to be authorized and settled through said financial network utilizing said non-depository account management system.
Whereby said individual's request for said third party service's financial transaction is settled on existing financial networks.

5. A method of claim 3 comprised of a data set for the identification and authorization of said requested third party service's financial transaction utilized by the financial instrument issuer

6. A method for settling said transaction of claim 3 comprising of new authorization and settlement process of said third party service's financial transaction between the third party service (the third party service's system and related settlement accounts, depository and/or non-depository accounts); between the initiator of the transaction (Financial Instrument Holder), between the acquiring processor of the transaction and the Issuer of the Financial Instrument and said depository account.

7. A method for settling said transaction of claim 3 comprising of a process for tracking the Pay-In and Pay-Out cycle of said third party service's financial transaction.

8. A method for settling said transaction of claim 3 comprising:
a. Providing various accounts as required for transaction settlement including a Financial Services Operating Account, a Funding Account, an Operating Account, Third Party Service Vendor's Operating or Corresponding Account, a Third Party Service Vendor Reserve Account, Merchant Operating Account, and
b. Providing various accounts as required for the auditing, recording, reporting and settlement data of the individual transaction settlement including a Non-Depository Financial Instrument Holder Account
Whereby an individual's request for said third party service transaction is audited, recorded and reported on when the transaction is completed.

9. An new use for the handling of a request, authorization, execution and settlement of said third party transaction over financial networks by an individual by providing a new use for electronic terminal devices to offer and facilitate said third party service transaction and a means for real-time sequential processing of said third party transaction over financial networks by an individual;

10. A new use of claim 9 comprising:
a. Providing a message protocol integrated into the electronic terminal interface device for transmission to and from the acquiring processor and
b. Providing said electronic terminal device to enable said third party service to offer said financial transaction to an individual and
c. Providing a customized interface for said electronic terminal device to enable said third party service to offer said financial transaction to an individual and
d. Providing said customized interface for said electronic terminal device to enable said individual to access said third party service's financial transaction and
e. Providing said customized interface for said electronic terminal device to enable the acquiring processor to offer said individual access said third party service's financial transaction
f. Providing said customized interface for said electronic terminal device to settle said third party service's financial transaction for said individual's request of said third party service's financial transaction and
g. Providing said electronic terminal device's screen interface for the entry and execution of said third party service's financial transaction.
Whereby, said requested third party service's financial transaction is executed in real-time.

11. A system for the management of said third party service's financial transaction over financial networks; by providing for the management system for said execution and settlement of said third party service's financial transaction over financial networks utilizing existing financial networks, merchants vendors servicing third party service's financial transactions, acquiring processors, financial instrument management systems, financial instrument issuers and financial network protocols:

12. A new use system of claim 11, utilizing Non-Depository accounts to manage the integration of the Individual's request for said third party transaction, including the identification of the third party service provider offering the service, the identification of the terms of the third party transaction, the authorization of the individual's acceptance for said third party service by said third party service, the authorization of said individuals request for said third party service, the authorization of the execution of said third party service's financial transaction to the individual, the authorization of the execution of said third party service's financial transaction for said acquiring processor, said financial instrument issuer, said merchant vendor and said electronic terminal device.

13. A new use system of claim 11 comprising:
a. Utilizing the checks and balances within Non-Depository & Depository accounts held by all parties to said transaction for said settlement of the transaction in real-time, and
b. Utilizing said Non-Depository & Depository accounts held by all parties to said transaction for said settlement of said transaction as required by said Third Party Service Provider, said Issuer of the Financial Instrument, said acquiring processor and financial networks for said Pay-In, Pay-Out fee settlement, and
c. Utilizing said Non-Depository & Depository accounts held by all parties to the transaction for said settlement of said third party service's financial transaction as required by said Third Party Service Provider, said Issuer of said Financial Instrument, said acquiring processor and financial networks for said Pay-In, Pay-Out fee settlement,
Whereby the use of said Non-Depository Account and related Management System enable said individual financial instrument holder to request and execute said Third Party Service Transaction on an existing financial network.
